(19) United States
(12) Patent Application Publication
(10) Pub. No.: US 2022/0146671 A1
(43) Pub. Date: May 12, 2022

(54) LASER RANGING RECEIVER DEVICE

(71) Applicant: VisionICs Microelectronics Technology Co., Ltd., Nanjing (CN)

(72) Inventors: Kunzhi Yu, Nanjing (CN); Cheng Li, Nanjing (CN); Xiaolin Huang, Nanjing (CN)

(73) Assignee: VisionICs Microelectronics Technology Co.,Ltd., Nanijing (CN)

(21) Appl. No.: 17/429,940

(22) PCT Filed: Sep. 26, 2019
(86) PCT No.: PCT/CN2019/108018

§ 371 Date: Aug. 10, 2021

(51) Int. Cl. G01S 17/08; G01S 7/481; G01S 7/4865; G01S 17/10

(52) U.S. Cl. CPC G01S 17/08; G01S 17/10; G01S 7/4865; G01S 7/4816

(57) ABSTRACT

A laser ranging receiver device, which is provided on a single chip and comprises a plurality of photoelectric conversion modules and a plurality of time-to-digital converters; clock generation and distribution modules; and a digital control circuit, the digital control circuit comprising a data storage module, a digital signal processing module, a timing control module, and a chip interface circuit. The photoelectric conversion modules are used to receive a laser reflection echo and generate a trigger signal, and the time-to-digital converters are used to receive various signals and perform calculation to generate digital signals of time information of the reflection echo; the data storage module is used to write and store the digital signals in parallel; the timing control module is used to generate laser emission signals; the digital signal processing module is used to generate corresponding distance information and intensity information; and the chip interface circuit is used to transmit the distance information and intensity information to an external system. The present invention integrates all of the modules on a single chip, and sets forth a solution for a reliable, low-cost, and miniaturized lidar system receiver.

### TECHNICAL FIELD

The present invention relates to the technical field of laser ranging, and particularly to a laser ranging receiver device using a direct time-of-flight scheme.

### BACKGROUND

Common laser ranging technologies can be roughly divided into four categories, namely pulse laser ranging, interferometric laser ranging, triangulation laser ranging and phase laser ranging. Pulse laser ranging is also called direct time-of-flight ranging. Its basic principle is as follows: a laser pulse emitted by laser device is irradiated on the target to be measured; time consumed by the laser to go back and forth is directly measured after laser echo reflected by the target passes through photoelectric signal conversion and time measurement circuit; and then the distance to the target object is calculated using this time and the constant c of the propagation speed of light. Pulse laser ranging has the advantages of fast measurement speed, high repetition frequency, simple structure and so on.

The design of traditional pulse laser ranging system requires multiple chips. These chips work together in a receiver system to realize three-dimensional ranging of objects. The multi-chip lidar receiver solution is complicated in design, high in cost, bulky, and low in reliability.

### SUMMARY OF THE INVENTION

Objects of the invention are as follows:

To provide a laser ranging receiver system chip design, which reduces the development difficulty and system cost of the lidar receiver system, improves the measurement accuracy, resolution and anti-interference ability of the system, and reduces the system volume and weight, thereby realizing single chip. To provide a laser ranging receiver chip for direct time-of-flight scheme, which improves the integration of laser ranging modules, and reduces the development difficulty and system cost of laser ranging modules, thereby realizing the low cost and miniaturization of the system.

To solve the above technical problems, the technical solutions adopted by the present invention are as follows:

a laser ranging receiver chip, the chip design integrates the following modules: a plurality of photoelectric conversion modules; a plurality of time-to-digital converters each comprising a single photon detector, a quench and reset circuit, an array element logic circuit, and a readout circuit; a clock generation module; a clock distribution module; as well as a digital control circuit comprising a data storage module, a digital signal processing module, a timing control module, and a chip interface circuit.

The technical solution of the present invention is as follows:

a laser ranging receiver device, which comprises: a plurality of photoelectric conversion modules, each receiving a laser reflection echo and generating a trigger signal; a plurality of time-to-digital converters connected to the plurality of photoelectric conversion modules, each of the time-to-digital converters being used to receive a laser emission signal as a start signal, the trigger signal as a termination signal, and a multi-phase high-speed clock signal, to calculate time difference between the start signal and the termination signal using the multi-phase high-speed clock signal as a reference, and to convert the time difference into a digital signal recording the time information of the reflection echo; as well as a digital control circuit connected to the plurality of time-to-digital converters, comprising: a data storage module connected to the plurality of time-to-digital converters, for writing and storing the digital signals recording the time information of the reflection echoes generated by the plurality of time-to-digital converters in parallel; a timing control module connected to the data storage module, for generating the laser emission signal; a digital signal processing module connected to the data storage module and the timing control module, for processing and calculating the digital signals recording the time information of the reflection echoes and generating corresponding distance information and intensity information under the control of the timing control module; and a chip interface circuit connected to the timing control module and the digital signal processing module, for transmitting the distance information and the intensity information to an external system under the control of the timing control module, wherein the laser ranging receiver device is provided on a single chip.

Further, in order to improve the measurement distance and accuracy of the laser ranging system, the photoelectric conversion modules each comprise: a single photon detector for detecting the laser reflection echo and generating the trigger signal; a quench and reset circuit connected to the single photon detector, for resetting the single photon detector to wait for the next trigger; and a readout circuit for transmitting the trigger signal to the corresponding time-to-digital converter and the digital control circuit.

Further, in order to reduce noise interference, the photoelectric conversion modules each further comprise an array element logic circuit connected to the single photon detector and the readout circuit, which is used to determine whether the trigger signal is triggered by noise or signal. The trigger signal is output by the readout circuit to the time-to-digital converter array if it is triggered by signal, and no output is performed if the trigger signal is triggered by noise. Meanwhile, in order to make more accurate measurements, the array element logic circuit is used to record the number of single photon detectors triggered by signals, and transmit the number information to the corresponding time-to-digital converter and the digital control circuit through the readout circuit.

Further, in order to improve the accuracy of detection, the laser ranging receiver device further comprises a clock generation module for generating multi-phase high-speed clock signals, which is connected to the timing control module and the time-to-digital converters.

Further, in order to cooperate with the clock generation module, the laser ranging receiver device further comprises a clock distribution module for sending the multi-phase high-speed clock signals to the plurality of time-to-digital converters.

Further, in order to make more reliable signal transmissions, the trigger signal is a voltage signal.

Further, in order to achieve a high degree of system integration, the single chip is achieved using traditional complementary metal oxide semiconductor (CMOS) process.

Further, in order to improve the signal-to-noise ratio, and remove device noise, background light and other noise interference, the modules in the digital control circuit work in parallel, and the signal-to-noise ratio is improved by means of a histogram.

Further, in order to enhance the precision and accuracy of detection, the digital control circuit is used to control the number of the photoelectric conversion modules and the time-to-digital converters.

Further, in order to speed up the test and improve the accuracy of ranging, the plurality of photoelectric conversion modules and the plurality of time-to-digital converters work in parallel under each laser exposure.

### Advantageous Effects of the Invention

(1) Each single photon detector array element adopts a single photon detector, which has the characteristics of high integration and high sensitivity, which improves the system pixel resolution of the and the measurement distance of the lidar system. (2) Each single photon detector array element uses an array element logic circuit to remove device noise, background light and other noise interference. (3) The timing control module controls the storage module, the digital signal processing module, the chip interface circuit, the readout circuits, the clock generation module, the clock distribution module, the photoelectric conversion modules and the time-to-digital converters, which improves the automation of the system and makes the system more stable. (4) Multiple modules in the system work in parallel at the same time, which reduces the exposure time required to meet the calculating requirements, thereby speeding up the test and improving the accuracy of ranging. (5) The highly integrated lidar receiver system integrates the detector chip, analog circuit chip, time-to-digital converter chip, digital signal processing chip, and interface communication chip into one chip, which provides a high-reliability, low-cost, and miniaturized receiver solution for lidar system design.

### BRIEF DESCRIPTION OF THE DRAWINGS

FIG. 1 is a block diagram of the laser ranging receiver device of the present invention.

FIG. 2 is a block diagram of each of the photoelectric conversion modules of the present invention.

### DETAILED DESCRIPTION OF THE INVENTION

The following describes the technical means adopted by the present invention to achieve the intended purpose of the invention in conjunction with the drawings and preferred embodiments of the present invention.

In order to facilitate the description, the parts in the figure are not drawn to scale. The proportions of certain sizes or other related scales may be highlighted and thus exaggerated, and the irrelevant details are not fully drawn, for the sake of simplicity.

### Example 1

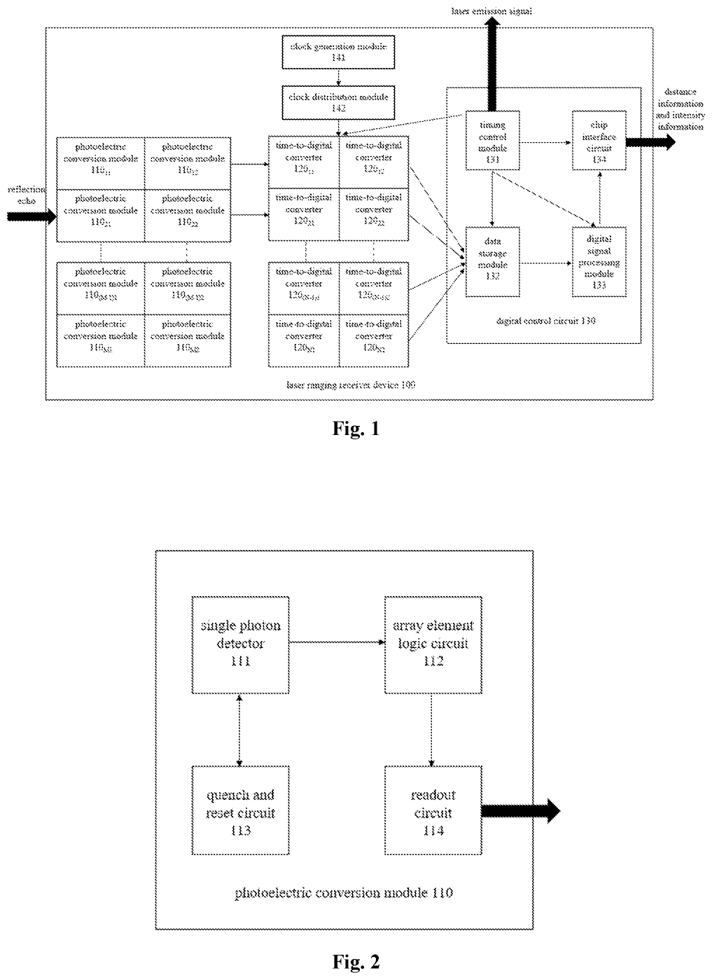

FIG. 1 is a block diagram of the laser ranging receiver device of the present invention. As shown in FIG. 1, the laser ranging receiver device 100 comprises a plurality of photoelectric conversion modules 110, a plurality of time-to-digital converters 120, a digital control circuit 130, a clock generation module 141, and a clock distribution module 142. In Example 1, in order to integrate the laser ranging receiver device 100, reduce the area of package, or facilitate coordination with external circuits, the plurality of photoelectric conversion modules 110 and the plurality of time-to-digital converters 120 can be fabricated on a single chip and placed on one side of the carrier or substrate; while the remaining modules, the digital control circuit 130, the clock generation module 141, and the clock distribution module 142 can be placed on the other side of the carrier or substrate. The digital control circuit 130 comprises a timing control module 131, a data storage module 132, a digital signal processing module 133 and a chip interface circuit 134.

The plurality of photoelectric conversion modules 110 may form a one-dimensional or two-dimensional array. As shown in FIG. 1, there are 2M photoelectric conversion modules 110₁₁ to 110_{M2} in total. Under normal working conditions, a reflection echo will be generated after a laser is emitted to a target object. The photoelectric conversion modules 110 are responsible for receiving reflection echoes, and converting the received reflection echoes into trigger signals. The trigger signals may be current signals or voltage signals.

The clock generation module 141 generates a multi-phase high-speed clock signal, which is the source clock of the timing control module 131. The clock generation module 141 and the timing control module 131 need to be synchronized, and then the start signals of the time-to-digital converters 120 can be synchronized signals, so as to ensure the accuracy of time measurement and thus the accuracy of distance measurement. The clock generation module 141 may include an oscillator as a signal source of a clock signal, and may also receive a clock signal generated by an external oscillator as a signal source. Because the lengths of the circuits between various photoelectric conversion modules 110 and the clock distribution module 142 are different, and because the frequency of the trigger signals is high, the clock generation module 141 generates a plurality of high-speed clock signals of different phases by using the clock signal of the signal source, and distributes them to various time-to-digital converters 120 through the circuit included in the clock distribution module 142. Accordingly, clock signals of different phases can be used to solve the problems of phase jitter, distortion, and offset caused by different circuit lengths.

The plurality of time-to-digital converters 120 may form a one-dimensional or two-dimensional array. As shown in FIG. 1, there are 2N time-to-digital converters 120₁₁ to 120_{N2} in total. The plurality of time-to-digital converters 120 may each be used to receive the multi-phase high-speed clock signal distributed from the clock distribution module 142, the trigger signal output by the corresponding photoelectric conversion module 110, and the start signal from the timing control module 131 indicating the laser emission time. Using the high-speed clock signal as a reference, the time-to-digital converter 120 can calculate the time difference between the start signal and the trigger signal as a termination signal. The time difference can be expressed as a time difference digital signal of the reflection echo time information. The time-to-digital converter 120 also transmits the time difference digital signal to the timing control module 131.

In Example 1, the number of the photoelectric conversion modules 110 and the number of the time-to-digital converters 120 are the same, and the relationship between them are one-to-one. Since there are 2M photoelectric conversion modules 110 and 2N time-to-digital converters 120 in the embodiment of FIG. 1, the number of the photoelectric conversion modules 110 is the same as the number of the time-to-digital converters 120 when M is equal to N. In other embodiments, in order to save cost, the photoelectric conversion modules 110 may time division multiplex the time-to-digital converters 120, thus the number of the time-to-digital converters 120 is reduced. Therefore, the number of the photoelectric conversion modules 110 may be greater than or equal to the number of the time-to-digital converters 120.

The data storage module 132 is used for storing multiple time difference values corresponding to the multiple time difference digital signals output from the time-to-digital converters 120. The timing control module 131 is used for generating the above-mentioned start signals indicating the laser emission times. The timing control module 131 controls the data storage module 132. After a certain number of digital signals of reflection echo time information are stored by the data storage module 132, they are processed and calculated by the digital signal processing module 133, and corresponding distance information and intensity information are obtained through calculation. The timing control module 131 sends a control signal to make the digital signal processing module 133 process the multiple time difference values. After the control signal is sent for a period of time, the data storage module 132 can be ordered to clear the stored multiple time difference values.

The digital signal processing module 133 may include a digital signal processor, or may include a specific logic circuit design to perform the following operations. When receiving a signal notification from the timing control module 131, the instruction or logic circuit executed by the digital signal processing module 133 can convert the multiple time difference values into multiple pieces of distance information and intensity information. Then, following the arrangement sequence of the photoelectric conversion modules 110, the chip interface circuit 134 outputs multiple pieces of distance information and intensity information to a host computer/other control system. The host computer/other control system can further generate point cloud data and/or three-dimensional scenes based on the distance information and intensity information.

The interface between the chip interface circuit 134 and an external system may be an exclusive specific interface or a standard industrial interface, such as I²C, USB, PCI, PCI-Express, etc., as long as the transmission rate of its specification can meet the distance information and intensity information for transmission.

### Example 2

FIG. 2 is a block diagram of each of the photoelectric conversion modules of the present invention. Example 2 is optimized based on Example 1. See FIG. 1 and FIG. 2, the laser ranging receiver device 100 of the present invention comprises a plurality of photoelectric conversion modules 110, a plurality of time-to-digital converters 120, a digital control circuit 130, a clock generation module 141, and a clock distribution module 142. In Example 2, in order to integrate the laser ranging receiver device 100, reduce the area of package, or facilitate coordination with external circuits, the plurality of photoelectric conversion modules 110 and the plurality of time-to-digital converters 120 can be fabricated on a single chip and placed on one side of the carrier or substrate; while the remaining modules, the digital control circuit 130, the clock generation module 141, and the clock distribution module 142 can be placed on the other side of the carrier or substrate. The digital control circuit 130 comprises a timing control module 131, a data storage module 132, a digital signal processing module 133 and a chip interface circuit 134.

As shown in FIG. 2, it is a block diagram of each of the photoelectric conversion modules 110 of the present invention. In Example 2, the photoelectric conversion modules 110 each comprise: a single photon detector 111, an array element logic circuit 112 connected to the single photon detector 111, a quench and reset circuit 113 connected to the single photon detector 111, and a readout circuit 114 connected to the array element logic circuit 112. The readout circuit 114 is also connected to the time-to-digital converters 120. The single photon detector 111 has the characteristics of high integration and high sensitivity, which improves the measurement distance and measurement accuracy of the laser ranging system. A voltage signal is triggered after a reflection echo is detected by the single-photon detector 111 in the array element.

When photons of a reflection echo hit the single photon detector 111, the photoelectric conversion module 110 may count the detected photons and generate a voltage signal. The voltage signal is transmitted to the array element logic circuit 112 and the quench and reset circuit 113. The quench and reset circuit 113 resets the single photon detector 111 to wait for the next photon trigger. The array element logic circuit 112 is used to remove device noise, background light and other noise interference, and to record the number of single photon detectors 111 triggered. The array element logic circuit 112 will determine whether this trigger signal is triggered by noise or signal. If it is triggered by signal, the voltage signal of the reflection echo is output by the readout circuit 114 to the time-to-digital converter 120. If it is triggered by noise, no output is performed. Meanwhile, the array element logic circuit 112 also records the number of single photon detectors 111 triggered by signals, and transmit the number information to the time-to-digital converter 120 and the digital control circuit 130 through the readout circuit 114, thereby recording the number information and then improving the signal-to-noise ratio.

In other embodiments, the array element logic circuit 112, the quench and reset circuit 113, and the readout circuit 114 may not form an element with the single photon detector 111. Multiple single photon detectors 111, multiple array element logic circuits 112, multiple quench and reset circuits 113 and multiple readout circuits 114 can be integrated into corresponding small modules, and these four small modules form a sub-array. That is, in some applications, a module array can be formed first, and then a complete photodetector array module can be formed. The array element logic circuit 112 is optional. That is, the photoelectric conversion module 110 may only comprise three modules: a single photon detector 111, a quench and reset circuit 113 connected to the single photon detector 111, and a readout circuit 114 connected to the single photon detector 111. The readout circuit 114 can directly transmit the voltage signal without considering whether it is triggered by noise.

The time-to-digital converter 120 receives laser emission signal generated by the timing control module 131 in the digital control circuit 130 as a start signal. The time-to-digital converter 120 also receives the voltage signal of the reflection echo generated by the single photon detector 111 as a termination signal, and converts the time difference between the start signal and the termination signal into a digital signal of the reflection echo time information based on the multi-phase high-speed clock signal. The clock generation module 141 generates a multi-phase high-speed clock signal, which is distributed to each time-to-digital converter 120 through the circuit included in the clock distribution module 142. The high-speed clock signal received by each time-to-digital converter 120 may have different phases. The high-speed clock signal of the same phase can be supplied to more than two time-to-digital converters 120. In other words, the relationship between the number of phases of the high-speed clock signal and the number of the time-to-digital converters 120 is not limited in the present invention. Using the high-speed clock signal as a reference, the time-to-digital converter 120 can calculate the time difference between the start signal and the voltage signal as the termination signal. The time difference can be expressed as a time difference digital signal of the reflection echo time information. The digital signal of the reflection echo time information generated by the time-to-digital converter 120 will be stored in the data storage module 132 in the digital control circuit 130. Multiple digital signals can be written into the data storage module 132 in parallel to reduce the exposure time required to meet the calculating requirements. The time-to-digital converter 120 also transmits the time difference digital signal to the timing control module 131.

In Example 2, the number of the time-to-digital converters 120 is different from the number of the photoelectric conversion modules 110, and the relationship between them are not one-to-one. M is greater than N, the number of photoelectric conversion modules 110 is greater than the number of time-to-digital converters 120, and 2M photoelectric conversion modules 110 may time division multiplex 2N time-to-digital converters 120, which has the effects of saving cost and reducing element size. The photoelectric conversion module 110 and the time-to-digital converter 120 work in parallel under each laser exposure, and input the corresponding digital conversion result to the digital control circuit 130, thereby speeding up the test and improving the accuracy of ranging.

In the digital control circuit 130, a histogram method is adopted to remove device noise, background light and other noise interference, and to improve the signal-to-noise ratio. A certain amount of data is required for histogram calculation, and multiple modules can work in parallel at the same time to shorten the exposure time. The timing control module 131 can control the number of the photoelectric conversion modules 110 and the time-to-digital converters 120 put into operation. In this embodiment, the digital control circuit 130 is connected to each photoelectric conversion module 110 and each time-to-digital converter 120 through control signals. These control signals are enable signals, which are used to turn on or turn off any photoelectric conversion module 110 or time-to-digital converter 120, which can reduce power consumption. Under the control of the timing control module 131, the chip interface circuit 134 transmits the distance and intensity information data to a host computer/other control system in a certain data format. The digital signal processing module 133 may include a digital signal processor, or may include a specific logic circuit design to perform the following operations. When the digital signal processing module 133 receives a signal notification from the timing control module 131, the instruction or logic circuit executed by the digital signal processing module 133 can convert the multiple time difference values into multiple pieces of distance information. Then, following the arrangement sequence of the single photon detector 111 of the photoelectric conversion module 110, the chip interface circuit 134 outputs the multiple pieces of distance information to an external device. The external device can further generate point cloud data and/or three-dimensional scenes based on the distance information. The external device can be a host computer or a control system.

The interface between the above-mentioned chip interface circuit 134 and an external system may be an exclusive specific interface or a standard industrial interface, such as I²C, USB, PCI, PCI-Express, etc., as long as the transmission rate of its specification can meet the distance information and/or intensity information for transmission.

In Example 2, in order to provide a high-reliability, low-cost, and miniaturized receiver solution, the above-mentioned receiver device is provided on a single chip. In order to generate point cloud data and/or three-dimensional spatial data, a digital signal processor is used to execute a software module, which is used to generate multiple pieces of distance information according to multiple time difference values after receiving an instruction from the timing control module.

The above are only the preferred embodiments of the present invention, and do not limit the present invention in any form. Although the present invention has been disclosed in the preferred embodiments as above, it is not intended to limit the present invention. Any person skilled in the art, without departing from the scope of the claims of the present invention, should be able to use the technical content disclosed above to make equivalent embodiments, with some variations or modifications being equivalent changes. Without departing from the scope of the claims of the present invention, any simple variations, equivalent changes and modifications made to the above embodiments based on the technical essence of the present invention fall within the content of the claims of the present invention.

What is claimed is:

1. A laser ranging receiver device, characterized in that, it comprises:
a plurality of photoelectric conversion modules, each receiving a laser reflection echo and generating a trigger signal;
a plurality of time-to-digital converters connected to the plurality of photoelectric conversion modules, each of the time-to-digital converters being used to receive a laser emission signal as a start signal, the trigger signal as a termination signal, and a multi-phase high-speed clock signal, to calculate time difference between the start signal and the termination signal using the multi-phase high-speed clock signal as a reference, and to convert the time difference into a digital signal recording the time information of the reflection echo; as well as
a digital control circuit connected to the plurality of time-to-digital converters, comprising:
a data storage module connected to the plurality of time-to-digital converters, for writing and storing the digital signals recording the time information of the reflection echoes generated by the plurality of time-to-digital converters in parallel;
a timing control module connected to the data storage module, for generating the laser emission signal;
a digital signal processing module connected to the data storage module and the timing control module, for processing and calculating the digital signals recording the time information of the reflection echoes and generating corresponding distance information and intensity information under the control of the timing control module; and
a chip interface circuit connected to the timing control module and the digital signal processing module, for transmitting the distance information and the intensity information to an external system under the control of the timing control module,
wherein the laser ranging receiver device is provided on a single chip.

2. The laser ranging receiver device of claim 1, characterized in that, the photoelectric conversion modules each comprise:
a single photon detector for detecting the laser reflection echo and generating the trigger signal;
a quench and reset circuit connected to the single photon detector, for resetting the single photon detector to wait for the next trigger; and
a readout circuit for transmitting the trigger signal to the corresponding time-to-digital converter and the digital control circuit.

3. The laser ranging receiver device of claim 2, characterized in that, the photoelectric conversion modules each further comprise an array element logic circuit connected to the single photon detector and the readout circuit, the array element logic circuit is used to determine whether the trigger signal is triggered by noise or signal, wherein the trigger signal is output by the readout circuit to the time-to-digital converter array if it is triggered by signal, and no output is performed if the trigger signal is triggered by noise; and the array element logic circuit is also used to record the number of single photon detectors triggered by signals, and transmit the number information to the corresponding time-to-digital converter and the digital control circuit through the readout circuit.

4. The laser ranging receiver device of claim 1, characterized in that, the laser ranging receiver device further comprises a clock generation module for generating multi-phase high-speed clock signals, which is connected to the timing control module and the time-to-digital converters.

5. The laser ranging receiver device of claim 4, characterized in that, the laser ranging receiver device further comprises a clock distribution module for sending the multi-phase high-speed clock signals to the plurality of time-to-digital converters.

6. The laser ranging receiver device of claim 1, characterized in that, the trigger signal is a voltage signal.

7. The laser ranging receiver device of claim 1, characterized in that, the single chip is achieved using traditional complementary metal oxide semiconductor process.

8. The laser ranging receiver device of claim 1, characterized in that, the modules in the digital control circuit work in parallel, and the signal-to-noise ratio is improved by means of a histogram.

9. The laser ranging receiver device of claim 1, characterized in that, the digital control circuit is used to control the number of the photoelectric conversion modules and the time-to-digital converters.

10. The laser ranging receiver device of claim 1, characterized in that, the plurality of photoelectric conversion modules and the plurality of time-to-digital converters work in parallel under each laser exposure.
